(19) United States
(12) Patent Application Publication
(10) Pub. No.: US 2009/0284532 A1
(43) Pub. Date: Nov. 19, 2009

(54) CURSOR MOTION BLURRING

(75) Inventors: Duncan R. Kerr, San Francisco, CA (US); Nicholas V. King, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/122,192

(22) Filed: May 16, 2008

(51) Int. Cl. G06T 11/20

(52) U.S. Cl. 345/442

(57) ABSTRACT

An electronic device for displaying a cursor with a trail is provided. The user may control electronic device operations by navigating the cursor on a display. To assist the user in identifying the current location of the cursor, the electronic device may define and display a trail indicating the prior positions of the cursor. For example, the electronic device may identify previous cursor positions and draw a curve, for example a spline, connecting the previous cursor positions and the current cursor position. The curve may have a varying width, thus forming a trail for which the wider portion is adjacent the cursor, and for which the narrower portion is adjacent the tip of the curve. The electronic device may instead or in addition modify the opacity of the curve, for example based on the instantaneous speed of the cursor. In some embodiments, other trail characteristics (e.g., size, color, opacity, path) may be modified based on prior cursor movements or cursor speed.

### BACKGROUND OF THE INVENTION

This invention is related to depicting the movement of a cursor displayed on a screen by a media system in response to inputs from a remote controller.

Electronic devices may be controlled by a user using many different approaches. In some embodiments, a cursor that may be controlled by the user is displayed on a screen of or coupled with the electronic device. Using an input mechanism such as a remote controller, the user may navigate the cursor on the screen over selectable options and provide a selection input. The electronic device may then perform any suitable action associated with the selected option.

To assist the user in tracking the location of the cursor, some electronic devices may show prior cursor locations as the cursor moves along the screen. For example, some computer operating systems may include an option for creating a trail behind the cursor. The operating system may continue to display a cursor in a position from which the cursor had moved for a time so that the user could see successive positions of the cursor (e.g., display the ten prior cursor images at a low refresh rate). This may be particularly necessary for displays that have low refresh rates, and for which a cursor could make large jumps on the screen between consecutive refreshes.

Although current displays often have high enough refresh rates that cursor trails are not required, determining the current position of cursors displayed on large screens designed to be placed at a distance from the user (e.g., cursors displayed on a television screen located across a room from the user) may be difficult. For example, the cursor may be so small that it is not easily seen from a distance, while making the cursor larger may take up such a large portion of the display that it becomes difficult, or perhaps unfeasible to select options displayed options (e.g., the cursor is larger than adjacent displayed options). There is a need, therefore, for a system by which a cursor may be easily tracked while maintaining the cursor at a reasonable size.

### SUMMARY OF THE INVENTION

A method for depicting the movement of a cursor displayed on a screen by a media system based on inputs received by a remote controller is provided.

An electronic device may be coupled to a display. To access and perform electronic device operations, the electronic device may direct the display to display a cursor, which a user may control using an input device. For example, the electronic device may include a wand with which the user may control the movement of the cursor (e.g., direct the cursor to move by moving the wand).

To assist the user in detecting the position of the cursor as it moves, the electronic device may define and display a trail that follows the movement of the cursor. The electronic device may use any suitable approach for defining the trail. In some embodiments, the electronic device may select a particular number of previous cursor positions, and define a curve passing through or adjacent the previous cursor positions. The number of previous cursor positions may be selected using any suitable approach. For example, the electronic device may select previous cursor positions displayed within a particular delay (e.g., cursor positions from the past 50 ms to 3 s). As another example, the electronic device may select a particular number of distinct prior cursor positions (e.g., past 10 cursor positions). As still another example, the electronic device may determine illustrative previous cursor positions based on the movement of the cursor (e.g., determine many previous positions for large or quick movements of the cursor).

The electronic device may define any suitable curve between the determined previous cursor positions. For example, the electronic device may define a spline between consecutive cursor positions to provide a smooth curve. Alternatively, other curves or lines may be used to connect the previous cursor positions. To provide a sense of direction of cursor movement, the electronic device may vary the size, color, opacity, or any other characteristic of the cursor trail based on the relative position of a point on the trail. For example, the electronic device may define a trail that tapers from the current cursor position to the end of the trail. The electronic device may use any suitable approach for determine the width of each point of the trail, including for example a linear or a non-linear correlation between the location of the point on the curve and the width of the point.

In some embodiments, one or more characteristics of the trail may be defined based on the speed with which the cursor moves. For example, the electronic device may determine the instantaneous velocity of the cursor (e.g., by determining the distance moved by the cursor over a short period of time, for example less than ten screen refreshes), and set the opacity of the trail based on the determined instantaneous velocity. Using this approach, the electronic device may set the trail to be transparent when the cursor moves slowly (and is easy for the user to track on screen), and opaque when the cursor moves quickly (and is more difficult to see on screen).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative media system in which a cursor may be displayed in accordance with one embodiment of the invention;

FIG. 2 is a schematic view of a wand in accordance with one embodiment of the invention;

FIG. 3 is an illustrative display that includes a cursor in accordance with one embodiment of the invention;

FIG. 4 is a schematic view of a display in which a cursor is displayed only at its current position as the cursor moves in accordance with one embodiment of the invention;

FIG. 5 is a schematic view of a display in which previous positions of the cursor are displayed as the user moves a cursor slowly in accordance with one embodiment of the invention;

FIG. 6 is a schematic view of a display in which previous positions of the cursor are displayed as the user moves a cursor quickly in accordance with one embodiment of the invention;

FIG. 7 is a schematic view of a display having a traced trail behind a cursor in accordance with one embodiment of the invention; and

FIG. 8 is a flowchart of an illustrative process for creating a trail depicting past locations of a cursor in accordance with one embodiment of the invention.

### DETAILED DESCRIPTION

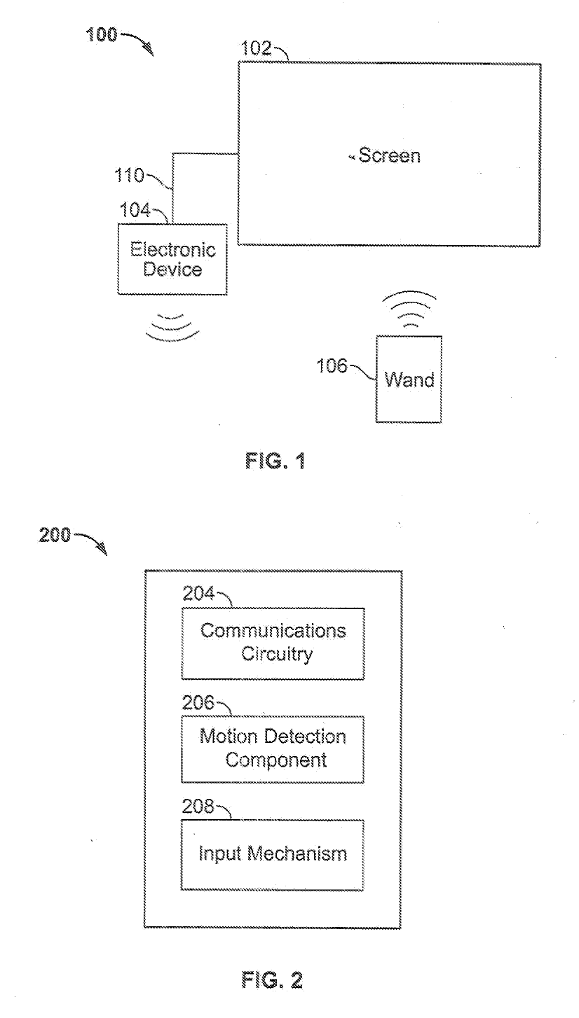

FIG. 1 is a schematic view of an illustrative media system in which a cursor may be displayed in accordance with one embodiment of the invention. In the example of FIG. 1, the display of the cursor is controlled based on the orientation of a remote wand. Other illustrative media systems used with wands are described in commonly owned U.S. patent application Ser. No. 12/113,588, filed May 1, 2007, and commonly owned U.S. patent application Ser. No. 12/002,063, filed Dec. 14, 2007, both of which are incorporated herein in their entirety. It will be understood, however, that the position of the cursor may be controlled using any suitable approach, including for example using a keyboard, directional keys, mouse, touch pad, touch screen, scroll wheel, or any other suitable input mechanism.

As shown in FIG. 1, media system 100 may include screen 102, electronic device 104 and wand 106. Screen 102 may be any suitable screen or display for displaying media or other content to a user. For example, screen 102 may include a television, a projector, a monitor (e.g., a computer monitor), a media device display (e.g., a media player or video game console display), a communications device display (e.g., a cellular telephone display), a component coupled with a graphical output device, any combinations thereof, or any other suitable screen.

Electronic device 104 may be coupled to screen 102 by link 110. Link 110 may be any suitable wired link, wireless link, or any suitable combination of such links for providing media and other content from electronic device 104 to screen 102 for display. For example, link 110 may include a coaxial cable, multi cable, optical fiber, ribbon cable, High-Definition Multimedia Interface (HDMI) cable, Digital Visual Interface (DVI) cable, component video and audio cable, S-video cable, DisplayPort cable, Visual Graphics Array (VGA) cable, Apple Display Connector (ADC) cable, USB cable, Firewire cable, or any other suitable cable or wire for coupling electronic device 104 with screen 102. As another example, link 110 may include any suitable wireless link for coupling electronic device 104 with screen 102. The wireless link may use any suitable wireless protocol including, for example, cellular systems (e.g., 0G, 1G, 2G, 3G, or 4G technologies), short-range radio circuitry (e.g., walkie-talkie type circuitry), infrared (e.g., IrDA), radio frequency (e.g., Dedicated Short Range Communications (DSRC) and RFID), wireless USB, Bluetooth, Ultra-wideband, high frequency systems (e.g., 900 MHz, 2.4 GHz, and 5.6 GHz communication systems), wireless local area network protocols (e.g., WiFi and Hiperlan), or any other suitable wireless communication protocol.

Electronic device 104 may include any suitable electronic device or component (e.g., control circuitry, a processor, camera circuitry and a display) for providing content for display to screen 102. For example, the electronic device may be operative to provide one or more output signal representing content, display screens, interactive elements, or any other suitable object operative to be displayed on screen 102. Upon receiving an output signal from electronic device 104, screen 102 may be operative to display the content or objects represented by the output signal. The content may include, for example, media (e.g., music, video and images), guidance screens (e.g., guidance application screens), software displays (e.g., Apple iTunes screens or Adobe Illustrator screens), prompts for user inputs, or any other suitable content. In some embodiments, electronic device 104 may be operative to generate content or displays that may be provided to screen 102. For example, electronic device 104 may include a desktop computer, a laptop or notebook computer, a personal media device (e.g., an ipod), a cellular telephone, a mobile communications device, a pocket-sized personal computer (e.g., an iPAQ or a Palm Pilot), a camera, a video recorder, a set-top box, or any other suitable electronic device.

In some embodiments, electronic device 104 may instead or in addition be operative to transmit content from a host device (not shown) to screen 102. For example, electronic device 104 may include a routing device, a device for streaming content to screen 102, or any other suitable device. In some embodiments, electronic device 104 may include an Apple TV sold by Apple Inc. of Cupertino, Calif. Electronic device 104 may be operative to receive content from the host device in any suitable manner, including any of the wired or wireless links described above in connection with link 110. The host device may be any suitable device for providing content to electronic device 104.

To control media system 100, the user may provide instructions to electronic device 104 using wand 106 coupled to electronic device 104. Wand 106 may include any suitable input device for providing user instructions to electronic device 104. Wand 106 may be formed into any suitable shape, including for example an elongated object, a round object, a curved object, a rectangular object, or any other suitable shape. Wand 106 may be operative to wirelessly transmit user instructions to electronic device 104 using any suitable wired or wireless communications protocol, including those described above in connection with link 110. For example, wand 106 may be operative to transmit instructions using an infrared communications protocol by which information is transmitted from wand 106 to an IR module incorporated within electronic device 104. As another example, wand 106 may communicate with electronic device 104 using a Bluetooth or WiFi communications protocol.

Wand 106 may include one or more input mechanisms (e.g., buttons, switches touch screen or touchpad) for providing user inputs to electronic device 104. In some embodiments, the input mechanism may include positioning or moving the wand in a specific manner. For example, wand 106 may be operative to identify a user input in response to the user flicking, spinning, rolling or rotating the wand in a particular direction or around a particular axis. As an illustration, a flick of the wrist may rotate wand 106, causing wand 106 to provide a SELECT or other instruction to electronic device 104. The user may move wand 106 in any direction with respect to the x axis (e.g., movement left and right on the screen), y axis (e.g., movement up and down on the screen), and z axis (e.g., movement back and forth from the screen).

Wand 106 may be operative to control a cursor (e.g., a pointer or a highlight region) displayed on screen 102 to access operations provided by electronic device 104. In some embodiments, the user may control the displacement of the cursor by the displacement of wand 106. Media system 100 may use any suitable approach for correlating the movement of wand 106 with the position of a cursor. For example, wand 106 may include one or more accelerometers, gyroscopes, or other motion detection components. Wand 106 may be operative to transmit motion detected by the motion detection component to electronic device 104. For example, wand 106 may identify motion in the x-y plane, and transmit the motion to electronic device 104, which may direct display screen 102 to displace a cursor in accordance with the motion of wand 106. Wand 106 may also include an input mechanism (e.g., a wheel or a touch strip) for providing inputs in the z direction to electronic device 104 (e.g., instead of or in addition to identifying motion of wand 106 in the z direction).

As another example for correlating the movement of wand 106 with the position of a cursor, any suitable number of IR modules (e.g., 2 modules) may be provided in the vicinity of screen 102. The IR modules may be operative to emit infrared light for detection by wand 106. Wand 106 may be operative to detect the light emitted by the IR modules, and determine its position and orientation relative to screen 106 by identifying its position and orientation relative to the IR modules. Wand 106 may be operative to transmit the position and orientation information to electronic device 104, which may convert the position and orientation information into coordinates for the cursor or into an action to be performed (e.g., zoom in or scroll). In some embodiments, wand 106 may be operative to convert the position and orientation information into coordinates for the cursor or an action to be performed, and transmit the coordinates or action to electronic device 104.

In some embodiments, wand 106 may be operative to emit infrared light, and the IR modules may be operative to receive the light emitted by wand 106. The IR modules and electronic device 104 may then be operative to determine, based on the angle at which the light emitted by wand 106 is received, and based on the intensity of the received light, the position of wand 106 relative to the IR modules.

In some embodiments, media system 100 may include a plurality of wands 106, for example one for each user, or a wand 106 and another input device or input mechanism, for example for controlling the position of a cursor. For the sake of clarity, only one wand 106 is shown in FIG. 1. Each wand or input device may be operative to control a different cursor, or a different portion of the screen. In some embodiments, each wand may have a different priority such that when more then one wand is in use, the wand with the highest priority controls operations displayed on screen 102. In some embodiments, each wand 106 may be operative to provide a unique signal to electronic device 104, thus allowing electronic device 104 to identify the user of media system 100, and thus provide a user-specific media experience (e.g., load user-specific settings or preferences, or provide user-specific media).

FIG. 2 is a schematic view of a wand in accordance with one embodiment of the invention. Illustrative wand 200 may include communications circuitry 204, motion detection component 206 and input mechanism 208. Communications circuitry 204 may be operative to transmit position and orientation information and user inputs from wand 200 to the electronic device (e.g., electronic device 104, FIG. 1) using any suitable communications protocol, including for example any communications protocol described above in connection with FIG. 1. In some embodiments, communications circuitry 204 may include a processor, memory, a wireless module and an antenna. The processor may be operative to control the wireless module for transmitting data stored or cached in the memory.

Communications circuitry 204 may transmit any suitable data. For example, the processor may be operative to transmit motion information received from motion detection component 206 (e.g., acceleration signals) and user inputs received from input mechanism 208. In some embodiments, the process may temporarily store the data in the memory to organize or process the relevant data prior to transmission by the wireless module. In some embodiments, the wireless module may transmit data at predetermined time intervals, for example every 5 ms. The wireless module may be operative to modulate the data to be transmitted on an appropriate frequency, and may transmit the data to electronic device 104. The wireless module may use any suitable communications protocol, including for example Bluetooth.

Motion detection component 206 may be operative to detect the movement of wand 200 as a user moves the wand. Motion detection component 206 may include any suitable element for determining a change in orientation of the wand. For example, motion detection component 206 may include one or more three-axes acceleration sensors that may be operative to detect linear acceleration in three directions (i.e., the x or left/right direction, the y or up/down direction, and the z or forward/backward direction). As another example, motion detection component 206 may include one or more two-axis acceleration sensors which may be operative to detect linear acceleration only along each of x or left/right and y or up/down directions (or any other pair of directions). In some embodiments, the acceleration sensor may include an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

Because in some embodiments motion detection component 206 may include only linear acceleration detection devices, motion detection component 206 may not be operative to directly detect rotation, rotational movement, angular displacement, tilt, position, orientation, motion along a non-linear (e.g., arcuate) path, or any other non-linear motions. Using additional processing, however, motion detection component 206 may be operative to indirectly detect some or all of these non-linear motions. For example, by comparing the linear output of motion detection component 206 with a gravity vector (i.e., a static acceleration), motion detection component 206 may be operative to calculate the tilt of wand 200 with respect to the y-axis.

In some embodiments, motion detection component 206 may include one or more gyro-sensors or gyroscopes for detecting rotational movement. For example, motion detection component 206 may include a rotating or vibrating element. In some embodiments, motion detection component 206 used in wand 200 may be operative to detect motion of wand 200 in the x-y plane (e.g., left/right and up/down movements of wand 200) so as to move a cursor or other element displayed on the screen (e.g., on screen 102, FIG. 1). For example, movement of wand 200 in the x-direction detected by motion detection component 206 may be transmitted to the electronic device associated with wand 200 to cause a cursor or another element of a display to move in the x-direction. To move a cursor or an element of the screen in the z-direction (e.g., when advancing into the screen in 3-D displays, or for zooming a display), wand 206 may include a separate input mechanism (described below).

The electronic device may define distinct acceleration curves, displacement curves, or velocity curves associated with different motion detection components or different axes for which motion detection components provide outputs. The different curves (e.g., acceleration curves) may be used to translate the physical movement of the wand into virtual movement of the cursor or other objects displayed by the electronic device to more closely reflect the user's intention when moving the wand. For example, different acceleration curves may be defined to account for the different ranges of motion of the user's hand, wrist or arm in different axes.

Input mechanism 208 may be any suitable mechanism for receiving user inputs. For example, input mechanism 208 may include a button, keypad, dial, a click wheel touchpad, a touch-sensitive input mechanism, a touchpad, or a touch screen. In some embodiments, the input mechanism may include a multi-touch screen such as that described in U.S. patent application Ser. No. 11/038,590, filed Jan. 18, 2005, which is incorporated by reference herein in its entirety. In some embodiments, input mechanism 208 may include a mechanism for providing inputs in the z-direction, and motion detection component 206 may provide inputs for movement in the x and y-directions. For example, input mechanism 208 may include a scroll wheel, touchpad, touch screen, arrow keys, joystick, or other suitable mechanism. In some embodiments, the z-direction mechanism may be operative to detect finger and thumb swipes in different directions. For example, swipes in one direction (e.g., up/down) may be provided to zoom or scroll the display, and swipes in another direction (e.g., left/right) may be provided to control playback of a track (e.g., fast forward/rewind or next/last).

In some embodiments, input mechanism 208 may include a mechanism for enabling communications circuitry 204 or motion detection component 206. For example, in response to receiving a user input on the motion enabling mechanism, wand 200 may enable motion detection component 206 to detect the user's movements of wand 200, and may direct communications circuitry 204 to provide outputs of motion detection component 206 to the electronic device (e.g., unless the user activates communications circuitry 204 or motion detection component 206, wand 200 may ignore movements of wand 200 and not provide motion information to the electronic device). This may allow the electronic device to ignore accidental movements of the wand and avoid adversely affecting the user's viewing experience. The motion enabling mechanism may include any suitable input mechanism, including for example an optical or capacitive sensor operative to detect the position of a user's hand or finger on input mechanism 208. For example, in response to determining that a user's finger is placed on an optical or capacitive sensor (e.g., the user's thumb is on the top of wand 200, or the user's hand is on the body of wand 200), wand 200 may enable communications circuitry 204 or motion detection component 206.

In some embodiments, input mechanism 208 may include thumbprint or fingerprint sensing components, or any other suitable biometric sensing components, to identify the user currently using wand 200. For example, a thumb or finger printing sensor may be embedded within the motion enabling mechanism or a the z-direction mechanism. In response to detecting a thumbprint or fingerprint, wand 200 or the electronic device may compare the detected print with a library of known prints to authenticate or log-in the user associated with the print. In response to identifying the user, the electronic device may load content specific to the identified user (e.g., a user profile, or access to the user's recordings), or provide the user with access to restricted content (e.g., content restricted by parental control options). If wand 200 or the electronic device does not recognize the thumb or finger print, the electronic device may load a default or guest profile or may prevent the user from accessing the electronic device.

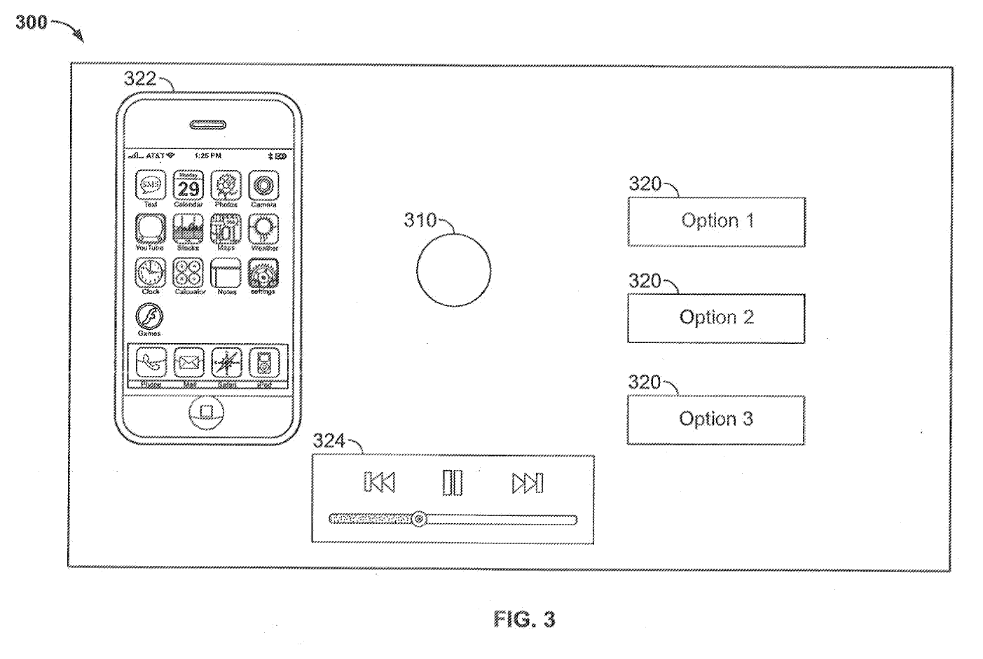

FIG. 3 is an illustrative display that includes a cursor in accordance with one embodiment of the invention. Display 300 may include cursor 310, which the user can navigate on the display using an input mechanism (e.g., wand 106). As the user moves the input mechanism, cursor 310 may move and be placed over any suitable elements displayed on the screen (e.g., on-screen options 320). In some embodiments, the user may use cursor 310 to select, move, rotate or edit objects (e.g., image 322) or control application functions (e.g., progress bar 324 for audio or video) displayed on screen 300.

To illustrate to the user that cursor 310 is displayed over elements displayed on screen (e.g., options 320, image 322 and progress bar 324), any suitable approach may be used. For example, the electronic device may first draw the background and displayed elements on screen 300, for example in a first layer (e.g., or in several layers, for example one per object). The objects in these layers may be considered mostly fixed, especially relative cursor 310. The electronic device may then draw cursor 310 in a second layer overlaid over the first layer (or several layers). Then, when the cursor is moved across the screen, the lower layer (or layers) may remain the same or substantially the same, while the second layer may change. The electronic device may blend layers using any suitable approach, including for example software blending, hardware accelerated OpenGL blending, and pure hardware blending. For example, the electronic device may draw the background and other content on the screen, and subsequently add the cursor on top of the content (e.g., using additive blending).

In some embodiments, each layer may be drawn in its one graphics context (e.g., into texture memory of a graphics card), and subsequently blended with other layers by drawing all of the layers in the main frame buffer. This approach may allow the electronic device to avoid a dedicated layer for the cursor in the hardware, as the software would be responsible for drawing (and redrawing, for example if the cursor moves) the content and the cursor in the main frame buffer. In some embodiments, the electronic device may instead draw the content in its own graphics layer, and the cursor in its own non-graphics layer (e.g., a cursor layer). To combine both layers on the display, the hardware (e.g., a graphics card) may blend the graphics and cursor layers. For example, an electronic device may include a video content layer (e.g., for displayed video or images), a graphics overlays layer (e.g., for navigation bars), and a cursor layer, all of which may be hardware blended to form the display.

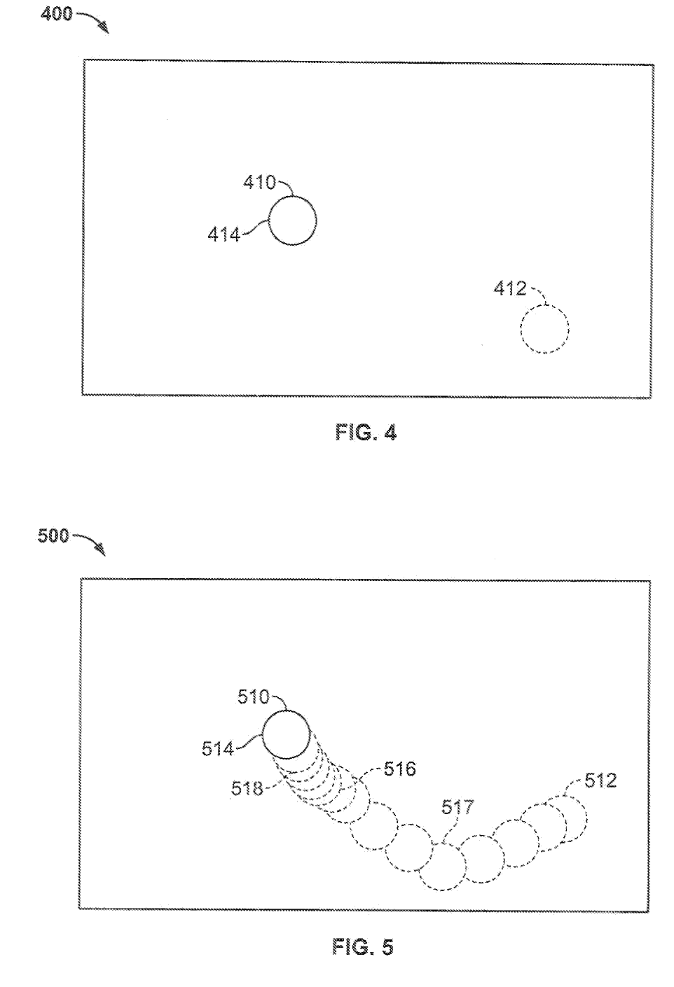

The electronic device may display cursor 310 as it moves on screen 300 using any suitable approach. FIG. 4 is a schematic view of a display in which a cursor is displayed only at its current position as the cursor moves in accordance with one embodiment of the invention. Display 400 may include cursor 410, and may also include displayed elements (e.g., some or all of the displayed elements of display 300, which are not shown to avoid overcomplicating the figure). In the implementation of display 400, the electronic device may display cursor 410 using only the set of pixels that reflects the current position the cursor. When cursor 410 is moved to a new position on display 400, the pixels that were previously used to show cursor 410 may instantaneously (or nearly instantaneously) change to the color of the object or background below the cursor's previous position (e.g., take the color of the next layer displayed underneath the cursor layer). For example, at the next refresh of display 400 (e.g., based on the refresh rate of the display), the value of the pixels at the previous position may be changed. For example, as cursor 410 moves from position 412 to position 414, display 400 may only include a representation for cursor 410 at current position 414, and not display any trace of cursor 410 at position 412, provided that display 400 has refreshed at least once to change the values of pixels at both positions 412 and 414.

When cursor 410 is moved slowly, this approach may be adequate for the user, as the user's eyes may be sufficiently adept to monitor and follow the cursor's position as it moves across display 400. If cursor 410 moves quickly, however, it may move faster than the eye can react, thus causing cursor 410 to appear to jump from a prior position (e.g., position 412) to a current position (e.g., position 414). If the user expects cursor 410 to move (e.g., the user provided the instruction to move cursor 410), this may be an expected result that does not adversely affect the user. If the user is far from display 400 however, or if cursor 410 is small or display 400 is large, the user may lose sight of cursor 410 as it moves, thus inconveniencing the user. This may be particularly true in implementations in which display 400 is provided by a television and the user is interacting with the television from a distance (e.g., from a couch across the room).

To assist the user in keeping track of the cursor's position as it moves across the screen, the electronic device may display both previous and the current positions of the cursor. FIG. 5 is a schematic view of a display in which previous positions of the cursor are displayed as the user moves a cursor slowly in accordance with one embodiment of the invention. Display 500 may include cursor 510, which the user may move from previous position 512 to current position 514 using any suitable approach. To assist the user in tracking the position of cursor 510, the electronic device may delay removing the display of cursor 510 for a particular amount of time after the cursor has been moved to a new position. For example, the electronic device may delay changing the value of the pixels at position 512 for a particular amount of time (e.g., in the range of 20 ms to 2 s, such as 500 ms) after cursor 510 has been moved away from position 512 (e.g., a decay delay). In some embodiments, the delay in changing the value of pixels may be measured in refreshes of display 500 (e.g., maintain the previous value of the pixels for at least 100 refresh cycles).

In some embodiments, the electronic device may instead or in addition change the opacity, size, color or any other attribute of the cursor display at previous positions, for example based on the same or a different decay delay. For example, the electronic device may direct the display to change the opacity, size, color or other attribute of the displayed cursor based on the delay since the cursor was in the particular position. The electronic device may use any suitable approach for relating the opacity, size, color or other attribute change and the time lapse. For example, a linear, polynomial, logarithmic, exponential, any other non-linear function, or combinations of these may be used to correlate the attribute change with the time lapse.

As the image of cursor 510 persists in prior locations, the user's eye may accumulate past images. In addition, because the display does not change the cursor image to the background image instantaneously (e.g., due to inherent limitations in the display), the display may also accumulate past images representing cursor 510. This dual accumulation of prior cursor positions, coupled with the intentional persistent display of the cursor (e.g., with or without varying opacity, size, color or other attribute) may cause the electronic device to display a trail 516 of previous cursor positions that is visible to the user.

One end of trail 516 may be current position 514 of cursor 510, while the other end of trail 516 may be the position of cursor 510 the particular time (e.g., the decay delay) ago. The other end of the line may therefore continuously change based on the previous positions of the cursor. If the cursor has been immobile for at least the decay delay, trail 516 may not be displayed, as it will be entirely incorporated in position 514.

When cursor 510 is moved slowly across display 500, consecutive positions of cursor 510 may overlap with each display refresh such that trail 516 appears to be a continuous trail. As shown in FIG. 5, cursor 510 moved more rapidly in near position 517, as indicated by the reduced overlap of consecutive cursor positions as display 500 refreshed, while cursor 510 moved more slowly near position 518, as indicated by the repeated overlap of consecutive cursor positions as display 500 refreshed. If the opacity of prior cursor positions is related to the decay delay (e.g., as described above), this may create a peculiar visual effect in which the middle of trail 516 (e.g., adjacent position 517 may be lighter than either end 512 or 514 of the trail), which may be confusing or distracting for the user.

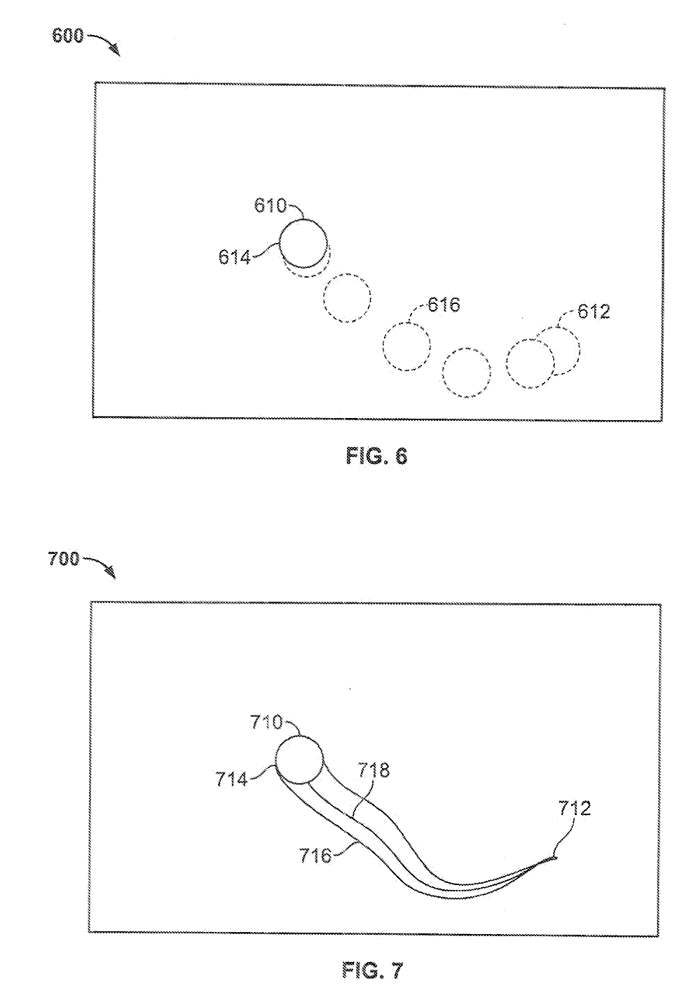

In addition, if cursor 510 is moved quickly on the display, trail 516 may become discontinuous. FIG. 6 is a schematic view of a display in which previous positions of the cursor are displayed as the user moves a cursor quickly in accordance with one embodiment of the invention. Display 600 may include cursor 610, which moved from position 612 to position 614. If the user directs the electronic device to move cursor 610 such that the distance moved between consecutive screen refresh rates exceeds the size of cursor 610, the display may include several distinct traces 616 of cursor 610. Thus, what was depicted as a trail (e.g., trail 516) may be replaced by a discontinuous collection of displayed prior cursor locations. This may create a stroboscopic effect that may distract the user, and may even detract the user from determining the past or current positions of cursor 610, effectively eliminating the advantage that delaying the removal of prior cursor positions.

The electronic device may use any suitable approach to avoid this defect when moving the cursor rapidly. Because the human eye processes images continuously rather than as discrete frames, the electronic device may create a blurred trail behind the cursor. For example, the electronic device may trace a trail passing through or near the previous n positions of the cursor on the display, and motion-blur the trail. FIG. 7 is a schematic view of a display having a traced trail behind a cursor in accordance with one embodiment of the invention. Display 700 may include cursor 710 and trail 716 behind cursor 710.

The electronic device may construct trail 716 using any suitable approach. First, the electronic device may determine the length of trail 716. The length may be defined using any suitable approach, including for example based on the number of previous cursor positions to use (e.g., cursor positions over n display refreshes), a defined decay delay (e.g., display cursor positions from last 2 s), a maximum displayed length on screen, or any other suitable approach. Once the length has been established, the electronic device may determine the position of cursor 710 for the length of trail 716. For example, the electronic device may sample and save in memory the previous cursor positions over a particular delay (e.g., save x and y coordinates of the cursor, and a time stamp t for each saved set of coordinates). To reduce the processing requirements, the electronic device may not identify every cursor position for the length of the trail (e.g., every cursor position over a decay delay), but may instead sample illustrative cursor positions at particular intervals. For example, the electronic device may identify cursor positions at particular time intervals. As another example, the electronic device may identify cursor positions within a maximum distance from each other. If consecutive sampled cursor positions are too distant, the electronic device may sample an additional cursor position, if available, between the prior sampled consecutive cursor positions.

Using the coordinates of previous cursor positions, the electronic device may calculate and define curve 718 starting at first cursor position 712, ending at current cursor position 714, and passing through or adjacent the previous cursor positions. The electronic device may use any suitable approach for defining curve 718. For example, the electronic device may define curve 718 by drawing straight or curved lines between adjacent x-y coordinates (as determined by the time stamp). As another example, the electronic device may draw a spline (e.g., a B-spline function), parametric curve, polynomial, or any other suitable curve or function. In some embodiments, the curves between adjacent positions may be drawn such that curve 718 is substantially smooth, thus avoiding a stroboscopic effect even when cursor 710 is moved quickly.

Each point along curve 718 may be assigned an age. For example, the age may be related to the value of the time stamp of the nearest x-y coordinates. As another example, the age may be determined by interpolating (e.g., linearly or non-linearly) the sample time for the start and end of curve 718 (e.g., such that the age of a point in the middle of curve 718 is half the age of position 712). The age of each point may be used to determine one or more characteristics of trail 716 at that point, including for example the size (e.g., width), opacity, color, or any other attribute of trail 716. For example, trail 716 may taper and become more transparent toward the end of the trail (e.g., position 712), as shown in FIG. 7. By assigning a width to each point of curve 718 (e.g., instead of placing several cursor representations along curve 718), trail 716 may be substantially continuous and not include any holes or discontinuities (e.g., unlike the approach of FIG. 6).

In some embodiments, the electronic device may use the cursor velocity to define at least one of the size, opacity, color or other attribute of trail 716. For example, the electronic device may determine the instantaneous (e.g., current velocity) of cursor 710 (e.g., by comparing the relative position of cursor 710 over a short period of time, for example a small number of screen refreshes) and modify the opacity of trail 716 based on the determined velocity. In one approach, the opacity may be related to instantaneous velocity such that when cursor 710 moves slowly, trail 716 is substantially transparent (e.g., only the cursor is visible), but trail 716 becomes progressively more opaque as the instantaneous velocity of cursor 710 increases. Then, cursor 716 may have not trail when it is immobile. This approach may allow the user to select displayed objects when cursor 710 moves slowly (e.g., without seeing a trail, which may be unnecessary at low speeds) while assisting the user in tracking the position of cursor 710 when it moves at higher speeds via trail 716 (and eliminating the stroboscopic effect).

In some embodiments, this approach may be applied to any other object that moves on a display. For example, the electronic device may draw a trail depicting the movement of an image selected by the user, for example using a cursor (e.g., instead of or in addition to displaying a trail for the cursor). As another example, the electronic device may display a trail for an object that moves automatically on the display (e.g., a screen saver with moving text or media), or any other suitable element moving on the display.

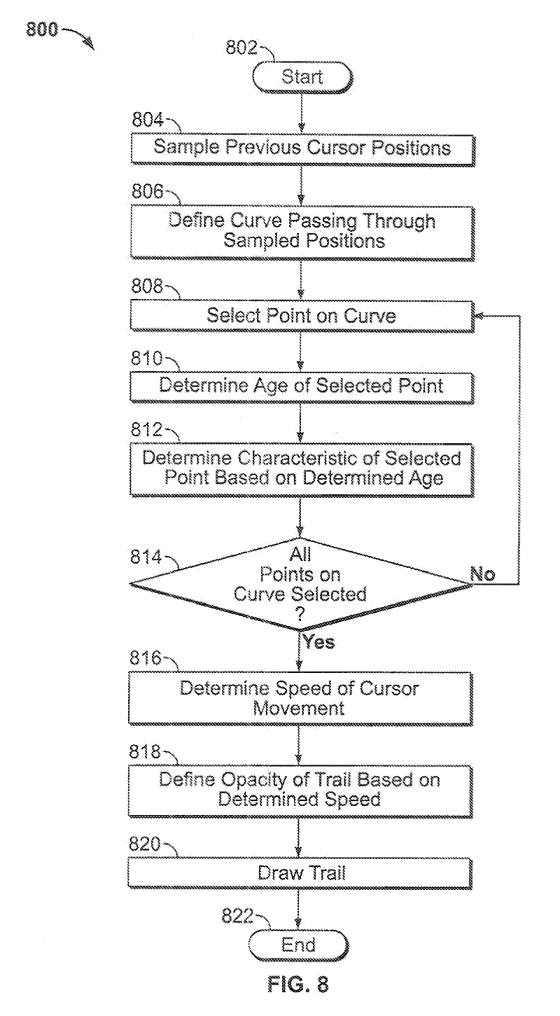

FIG. 8 is a flowchart of an illustrative process for creating a trail depicting past locations of a cursor in accordance with one embodiment of the invention. Process 800 may begin at step 802. At step 804, the electronic device may sample previous cursor positions. For example, the electronic device may determine and save to memory (e.g., a buffer) the x and y coordinates of prior cursor positions. The electronic device may save any suitable number of prior positions, including for example prior positions for up to a decay delay for the displayed cursor (e.g., 2 s). The electronic device may sample cursor positions at any suitable rate, including for example at the display refresh rate or at a lower rate. In some embodiments, the electronic device may sample additional cursor positions if it determines that two consecutive sampled positions exceed certain parameters (e.g., are too far apart in space or time). In some embodiments, the electronic device may associate each sampled position with a time value (e.g., a time stamp, for example for determining the order of the sampled cursor positions).

At step 806, the electronic device may define a curve passing through the sampled positions. For example, the electronic device may define a spline (e.g., a B-spline) passing through the sampled positions. The defined curve may be selected so that the trail behind the cursor is substantially smooth. At step 808, the electronic device may select a point on the curve. For example, the electronic device may select the first of the sampled positions. As another example, the electronic device may identify a plurality of points distributed along the curve, and select one. The plurality of points may be distributed using any suitable approach, including for example uniformly or based on the shape of the curve (e.g., more points near curved segments, and fewer points along straighter segments). The electronic device may identify any suitable number of points, including for example a number based on the length of the curve.

At step 810, the electronic device may determine the age of the selected point. For example, the electronic device may determine the age (e.g., the time stamp) of the nearest sampled positions, and define an age based on the selected point's position relative to the sampled positions (e.g., based on a linear or non-linear time progression between the sampled positions). This approach may allow the electronic device to account for changes in speed or acceleration as the user moved the cursor. As another example, the electronic device may determine the position of the point relative the ends of the curve, and define an age based on the determined position (e.g., based on a linear or non-linear time progression along the curve). This approach may eliminate or ignore changes in speed or acceleration as the user moved the cursor, thus providing more straightforward display for the user.

At step 812, the electronic device may determine the characteristics of the selected point on the trail based on the determined age. For example, the electronic device may determine the size (e.g., width), color, opacity, or any other attribute of the selected point based on the determined age. Using one approach, the width of the trail may progressively taper from the current position of the cursor based on the age of each point along the curve (e.g., such that halfway along the curve, the trail width is half the width of the cursor).

At step 814, the electronic device may determine whether all points on the curve have been selected. For example, the electronic device may determine whether all of the identified plurality of points have been selected. If the electronic device determines that not all of the points on the curve have been selected, process 800 may return to step 808 and select the next point. If the electronic device instead determines that all of the points on the curve have been selected, process 800 may move to step 816.

At step 816, the electronic device may determine the current speed of the cursor movement. For example, the electronic device may determine the instantaneous cursor speed (e.g., based on consecutive positions of the cursor over a short period of time). At step 818, the electronic device may determine the opacity of the trail based on the determined cursor speed. For example, the electronic device may associate slow cursor movements with a transparent trail, and fast cursor movements with a opaque trail. The electronic device may use any suitable approach for associating opacity levels with cursor speed, including for example linear or non-linear correlations.

At step 820, the electronic device may draw a trail along the defined curve, where the trail has the characteristics (e.g., width and color) determined at step 812, and the opacity defined at step 818. Process 800 may then end at step 822. In some embodiments, process 800 may repeat for some or all refreshes of the display.

The above described embodiments of the present invention are presented for purposes of illustration and not of limitation, and the present invention is limited only by the claims which follow.

What is claimed is:

1. A method for displaying a cursor trail, comprising:
detecting the current cursor position and the previous n positions of the cursor on the screen, where n is larger than 2;
defining a curve passing adjacent the detected cursor positions and the current cursor position; and
drawing a trail having a varying width along the defined curve.

2. The method of claim 1, further comprising:
determining the width of a point on the curve based on the position of the point relative the current cursor position.

3. The method of claim 1, further comprising:
determining the age of a point on the curve; and
selecting the width of the point based on the determined age.

4. The method of claim 1, wherein detecting further comprises:
determining the previous cursor position forming the tip of the trail; and
detecting the previous n-1 positions between the determined cursor position and the current cursor position.

5. The method of claim 4, wherein determining further comprises setting a trail length.

6. The method of claim 5, further comprising:
determining that the cursor has moved; and
re-drawing the trail from the moved position of the cursor.

7. The method of claim 6, wherein re-drawing the trail further comprises re-drawing the trail with a different previous cursor position forming the tip of the trail.

8. The method of claim 1, further comprising:
determining the speed of the cursor as it moves; and
changing the opacity of the displayed trail based on the determined speed.

9. A system for displaying a cursor trail, comprising an input device, control circuitry and a display, the control circuitry operative to:
direct the display to display a cursor;
sample a plurality of prior cursor positions;
define a curve passing through the sampled plurality of positions; and
directing the display to a draw a trail having varying width along the curve.

10. The system of claim 9, wherein the control circuitry is further operative to store the sampled plurality of positions as x-y coordinates.

11. The system of claim 10, wherein the control circuitry is further operative to associate a time stamp with each stored position.

12. The system of claim 11, wherein the control circuitry is further operative to:
determine the age of each stored position based on the associated time stamp; and
setting the width of the trail at each stored position based on the determined age.

13. The system of claim 9, wherein the control circuitry is further operative to receive an instruction from the input device to move the cursor.

14. The system of claim 9, wherein the control circuitry is further operative to direct the display to modify the trail in response to receiving the instruction to move the cursor.

15. An electronic device operative to direct a display to display a cursor having a trail, comprising control circuitry operative to:
detect a plurality of previous positions of the cursor;
define a curve passing adjacent the plurality of previous positions and the current cursor position; and
draw a trail along the curve.

16. The electronic device of claim 15, wherein the curve is a spline passing through the detected plurality of previous cursor positions.

17. The electronic device of claim 16, wherein the trail tapers from the current cursor position to the tip of the trail.

18. The electronic device of claim 15, wherein the control circuitry is further operative to:
determine that the cursor has moved;
detect a plurality of more recent previous positions of the cursor; and
define a new curve based on the detected plurality of more recent cursor positions.

19. The electronic device of claim 15, wherein the control circuitry is further operative to:
detect that the cursor has moved;
determine the speed with which the cursor has moved; and
set the opacity of the trail based on the determined speed.

20. The electronic device of claim 19, wherein the trail is opaque when the determined speed is high.

21. The electronic device of claim 19, wherein the trail is transparent when the determined speed is low.

22. A machine-readable medium for displaying a cursor trail, comprising machine program logic recorded thereon for:
detecting the previous n positions of the cursor on the screen, where n is larger than 2;
defining a curve passing adjacent the detected cursor positions and the current cursor position; and
drawing a trail having a varying width along the defined curve.

23. The machine-readable medium of claim 22, further comprising additional machine program logic recorded thereon for:
determining the age of a point on the curve; and
selecting the width of the point based on the determined age.
